(19) United States
(12) Patent Application Publication
(10) Pub. No.: US 2009/0147125 A1
(43) Pub. Date: Jun. 11, 2009

(54) IMAGE PICK-UP APPARATUS AND COMPUTER READABLE RECORDING MEDIUM

(75) Inventors: Jun MURAKI, Tokyo (JP); Kimiyasu Mizuno, Tokyo (JP); Koki Dobashi, Tokyo (JP)

Correspondence Address: FRISHAUF, HOLTZ, GOODMAN & CHICK, PC, 220 Fifth Avenue, 16TH Floor, NEW YORK, NY, 10001-7708, US

(73) Assignee: Casio Computer Co., Ltd., Tokyo (JP)

(21) Appl. No.: 12/326,408

(22) Filed: Dec. 2, 2008

(30) Foreign Application Priority Data
Dec. 5, 2007 (JP) 2007-314183

(51) Int. Cl. H04N 5/235; G03B 13/00

(52) U.S. Cl. 348/345; 348/362; 348/E05.034

(57) ABSTRACT

A shooting operation using a short exposure time and a shooting operation using a long exposure time are performed in turn repeatedly.

Frame image data “B” obtained by the shooting operation using a long exposure time is displayed and recorded. Frame image data “A” obtained by the shooting operation using a short exposure time is used to evaluate an image, that is, to detect a face area in said image data and/or calculate AF evaluation value.

### BACKGROUND OF THE INVENTION

1. Field of the Invention

The present invention relates to an image pick-up apparatus with a moving image shooting function.

2. Description of the related Art

A technique in image pick-up apparatuses is known, that evaluates the contrast of an image to perform an automatic focusing operation. For displaying a smooth moving image, it is preferable to use a long exposure time for shooting moving image data. In the case where an image is evaluated during a moving image shooting operation, for example, when the contrast of the image is evaluated to perform the automatic focusing operation, the image of frame image data shot using a long exposure time cab be jiggled, resulting in loss of high frequency components of the image. Therefore, it is hard to evaluate the contrast of the image with accuracy during the moving image shooting operation.

### SUMMARY OF THE INVENTION

The present invention has an object to provide a technique that is capable of obtaining moving image data for displaying a smooth moving image and enhances accuracy of evaluation of an image.

According to one aspect of the invention, there is provided an image pick-up apparatus which comprises an image pick-up unit for shooting an object, a first shooting control unit for controlling the image pick-up unit to shoot the object at least once under a first exposure condition, thereby obtaining first image data, an image evaluating unit for evaluating an image of the first image data obtained by the first shooting control unit, a shooting condition adjusting unit for adjusting a shooting condition to be set to the image pick-up unit based on an evaluation result by the image evaluating unit, a second shooting control unit for controlling the image pick-up unit to shoot the object at least once with the shooting condition adjusted by the shooting condition adjusting unit under a second exposure condition different from the first exposure condition, thereby obtaining second image data, an image data obtaining unit for performing shooting by the first shooting control unit and shooting by the second shooting control unit in turn repeatedly, thereby obtaining plural pieces of image data, and a moving image data producing unit for producing moving image data from plural pieces of second image data, wherein the plural pieces of second image data are included in the plural pieces of image data obtained by the image data obtaining unit.

According to other aspect of the invention, there is provided a computer readable recording medium to be mounted on an image pick-up apparatus having a built-in computer, the computer readable recording medium storing a computer program when executed to make the computer function as an image pick-up unit comprising an image pick-up unit for shooting an object, a first shooting control unit for controlling the image pick-up unit to shoot the object at least once under a first exposure condition, thereby obtaining first image data, an image evaluating unit for evaluating an image of the first image data obtained by the first shooting control unit, a shooting condition adjusting unit for adjusting a shooting condition to be set to the image pick-up unit based on an evaluation result by the image evaluating unit, a second shooting control unit for controlling the image pick-up unit to shoot the object at least once with the shooting condition adjusted by the shooting condition adjusting unit under a second exposure condition different from the first exposure condition, thereby obtaining second image data, an image data obtaining unit for performing shooting by the first shooting control unit and shooting by the second shooting control unit in turn repeatedly, thereby obtaining plural pieces of image data, and a moving image data producing unit for producing moving image data from plural pieces of second image data obtained by the second shooting control unit, wherein the plural pieces of second image data are included in the plural pieces of image data obtained by the image data obtaining unit.

### BRIEF DESCRIPTION OF THE DRAWINGS

FIG. 1 is a block diagram of a digital camera according to embodiments of the present invention.

FIG. 2 is a timing chart of a moving image shooting operation in the first embodiment of the invention.

FIG. 3 is a view illustrating plural pieces of obtained frame image data and frame numbers “n” of the frame image data.

FIG. 4 is a flow chart of a moving image shooting/recording operation in the first embodiment of the invention.

FIG. 5(A) is a flow chart of a real time displaying operation in the moving image shooting/recording process in the first embodiment of the invention.

FIG. 5(B) is a flow chart of AF controlling operation in the moving image shooting/recording process in the first embodiment of the invention.

FIG. 6 is a timing chart of a moving image shooting operation in the second embodiment of the invention.

FIG. 7 is a flow chart of a moving image shooting/recording operation in the second embodiment of the invention.

FIG. 8 is a flow chart of a face detecting operation in the moving image shooting/recording process in the second embodiment of the invention.

### PREFERRED EMBODIMENTS OF THE INVENTION

Now, embodiments of an image pick-up apparatus of the invention, which is adopted in a digital camera 1 will be described in detail with reference to the accompanying drawings.

### A. Configuration of the Digital Camera

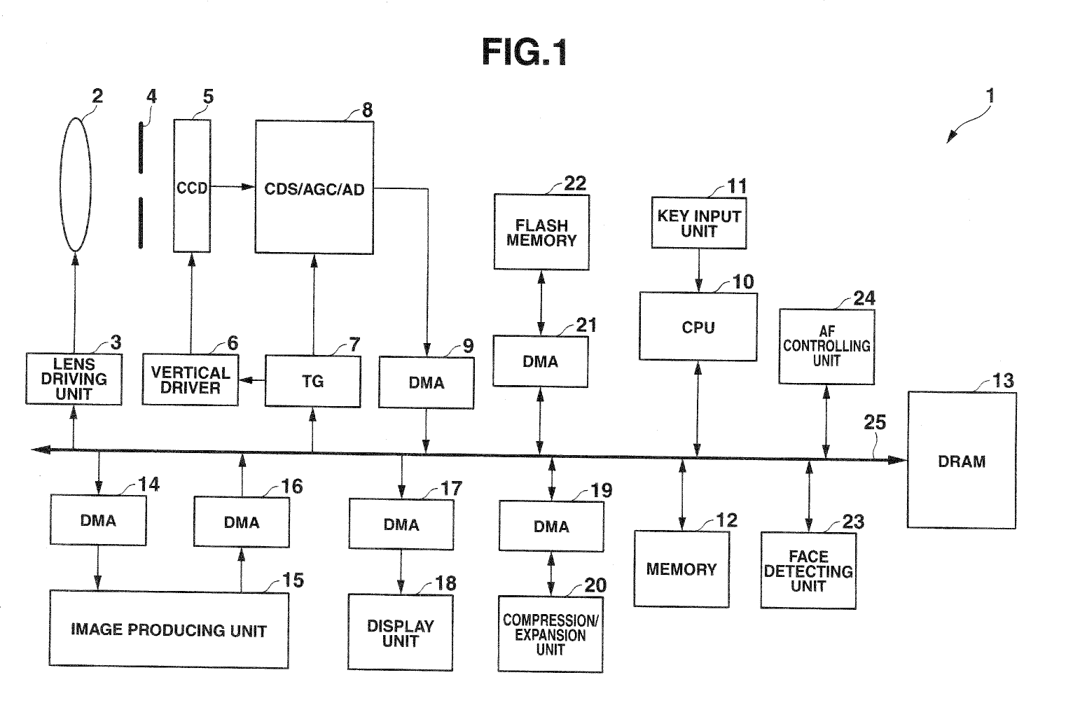

FIG. 1 is a block diagram illustrating a circuit configuration of the digital camera 1 using the image pick-up apparatus according to the present invention.

The digital camera 1 comprises an image pick-up lens 2, lens driving unit 3, aperture mechanism 4, CCD 5, vertical driver 6, TG (Timing Generator) 7, unit circuit 8, DMA controller (hereinafter, simply “DMA”) 9, CPU 10, key input unit 11, memory 12, DRAM 13, DMA 14, image producing unit 15, DMA 16, DMA 17, display unit 18, DMA 19, compression/expansion unit 20, DMA 21, flash memory 22, face detecting unit 23, AF controlling unit 24 and bus 25.

The image pick-up lens 2 includes a focus lens and zoom lens. The image pick-up lens 2 is connected with the lens driving unit 3. The lens driving unit 3 comprises a focus motor for moving the focus lens along its optical axis, and a zoom motor for moving the zoom lens along its optical axis, arid further comprises a focus motor driver and zoom motor driver, wherein the focus motor driver and zoom motor driver drive the focus motor and zoom motor in accordance with control signals sent from CPU 10, respectively

The aperture mechanism 4 has a driving circuit. The driving circuit operates the aperture mechanism 4 in accordance with a control signal sent from CPU 10.

The aperture mechanism 4 serves to adjust the amount of incident light onto CCD 5. Exposure (the amount of light received by CCD 5) is adjusted by setting an aperture and shutter speed.

CCD 5 is scanned by the vertical driver 6, whereby light intensities of R, G, B color values of an object are photoelectrically converted into an image pick-up signal every certain period. The image pick-up signal is supplied to the unit circuit 8. Operations of the vertical driver 6 and unit circuit 8 are controlled by CPU 10 in accordance with a timing signal of TG 7. Further, CCD 5 has a function of an electronic shutter. The operation of the electronic shutter is controlled by the vertical driver 6 depending on the timing signal sent from TG 7. The exposure time varies depending on the shutter speed of the electronic shutter.

The unit circuit 8 is connected with TG 7, and comprises CDS (Correlated Double Sampling) circuit, AGC circuit and A/D converter, wherein the image pick-up signal is subjected to a correlated double sampling process in CDS circuit, and to an automatic gain control process in AGC circuit, and then converted into a digital signal by A/D converter. The digital signal (Bayer pattern image data, hereinafter “Bayer data”) of CCD 5 is sent through DMA 9 to the buffer memory (DRAM 13) to be recorded therein.

CPU 10 is an one chip microcomputer having a function of performing various processes including a recording process and displaying process. The one chip micro-computer controls the operation of the whole digital camera 1.

In particular, CPU 10 has a function of sequential shooting using two different exposure times to obtain image data and a function of discriminating and displaying a face area detected by the face detecting unction 23, as will be described later.

The key input unit 11 comprises plural manipulation keys including a shutter button for instructing to shoot a still image and/or shoot a moving image, a displaying-mode switching key, a reproduction mode switching key, reproducing key, temporarily stop key, cross key, SET key, etc. When manipulated by a user, the key input unit 11 outputs an appropriate manipulation signal to CPU 10.

In the memory 12 are stored necessary data and a control program necessary for CPU 10 to control various operations of the digital camera 1. CPU 10 works in accordance with the control program.

DRM 13 is used as a buffer memory for temporarily storing the image data obtained by CCD 5, and also used as a work memory of CPU 10.

DMA 14 serves to read the image data (Bayer data) from the buffer memory and to output the read image data to the image producing unit 15.

The image producing unit 15 performs a pixel correction process, gamma correction process, and white balance process on the image data sent from DMA 14, and further generates luminance color difference signals (YUV data). In short, the image producing unit 15 is a circuit block for performing an image processing.

DMA 16 serves to store in the buffer memory the image data (YUV data) of the luminance color difference signals subjected to the image processing in the image producing unit 15.

DMA 17 serves to read and output the image data (YUV data) stored in the buffer memory to the display unit 18.

The display unit 18 has a color LCD and a driving circuit and displays an image of the image data (YUV data).

DMA 19 serves to output the image data (YUV data) and image data compressed and stored in the buffer memory to the compression/expansion unit 20, and to store in the buffer memory the image data compressed and/or the image data expanded by the compression/expansion unit 20.

The compression/expansion unit 20 serves to compress and/or expand image data, for examples in JPEG format and/or MPEG format.

DMA 21 serves to read the compressed image data stored in the buffer memory and to store the read image data in the flash memory 22, and further serves to read the compressed image data recorded in the flash memory 22 and to store the read compressed image data in the buffer memory.

The face detecting unit 23 serves to perform a face detecting process for detecting a face area in the image data obtained by CCD 5. In other words, the face detecting unit 23 judges whether the face area has been detected or not, and further judges how many the face areas have been detected. The face detecting process is a well known technique and therefore will not be described in detail. But in the face detecting process, for instance, featuring data of a face of a person previously stored in the digital camera 1 and the image data are compared and referred to each other to judge in which area of the image data the face of a person is found, wherein the featuring data of the face of a person includes data of eye, eyebrows, nose, mouth and ear, and a face contour etc.

AF controlling unit 24 serves to perform an auto-focusing operation based on plural pieces of obtained image data. More specifically, AF controlling unit 24 sends a control signal to the lens driving unit 3 to move the focus lens within a focusing range, and calculates AF evaluation value of AF area of the image data obtained by CCD 5 at a lens position of the focus lens (or evaluates an image), whereby the focus lens is moved to a focusing position based on the calculated AF evaluation value to bring the image pick-up lens in focus. The AF evaluation value is calculated from high frequency components of AF area of the image data, and the larger AF evaluation value indicates the more precise focusing position of the image pick-up lens.

### B. Moving Image Shooting Operation

Operation of the digital camera 1 according to the present embodiment (first embodiment) will be described.

There are prepared two exposure modes (first and second modes) in the digital camera 1 in the first embodiment. The first mode is an exposure mode “B” in which CCD 5 is exposed to light for an exposure time “B” appropriate for shooting a moving image, and the second one is an exposure mode “A” in which CCD 5 is exposed to light for an exposure time “A” appropriate for shooting a still image, wherein the exposure time “A” is shorter than the exposure time “B”. The exposure mode is switched every shooting operation. That is, when a shooting operation is performed in the exposure mode “A”, then exposure mode “A” is switched to the exposure mode “B” for the following shooting operation, and when the shooting operation is performed in the exposure mode “B”, then exposure mode “B” is switched to the exposure node “A” again for the following shooting operation

CCD 5 is capable of shooting an object at least at a frame period of 300 fps. CCD 5 is exposed to light for the exposure time “A” in the exposure mode “A”, wherein the exposure time “A” (for example, 1/1200 sec.) is shorter than one frame period, and is exposed to light for the exposure time “B” (for example, 1/75 sec.) of a four frame period in the exposure mode “B”. In the present embodiment (first embodiment), one frame period is set to 1/300 sec.

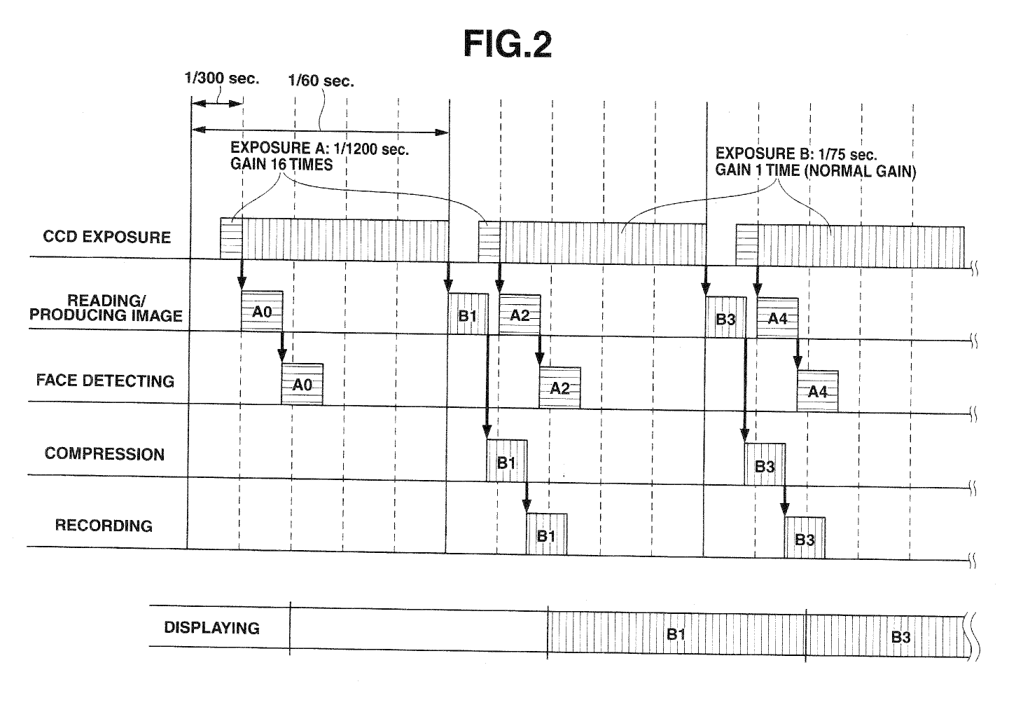

FIG. 2 is a time chart of the moving image shooting operation.

As shown in FIG. 2, the shooting operation is performed alternately in the exposure mode “A” and the exposure mode “B”.

An operation of reading image data from CCD 5 and an operation of the image producing unit 15 to generate luminance color difference signals are performed within a period of less than one frame period (less than 1/300 sec.) In short, operation of the image producing unit 15 for producing image data of the luminance color difference signals from Bayer data and for storing in the buffer memory the produced image data of the luminance color difference signal is performed within a period of less than one frame period (less than 1/300 sec.), wherein Bayer data is previously read from CCD 5 and stored in the buffer memory through the unit circuit 8. An aperture, sensitivity (for example, gain value), and ND (Neutral Density) filter are adjusted to balance in luminance level between frame image data obtained in the exposure mode “B” and frame image data obtained in the exposure mode “A”. It is presumed in the present embodiment that only the gain value is adjusted to balance in luminance level between the frame image data obtained in the exposure mode “B” and the frame image data obtained in the exposure mode “A” and that the gain value is set a normal gain value for shooting operation in the exposure mode “B” and the gain value is set to 16 times of the normal gain value for shooting operation in the exposure mode “A”, whereby the luminance level is balance between the frame image data obtained in the exposure mode “B” and the frame image data obtained in the exposure mode “A”.

The face detecting process for detecting a face area in image data of the luminance color difference signals, compressing process for compressing the image data of the luminance color difference signals and recording process for recording the compressed image data are performed within a period of less than one frame period. In short, a series of operations are performed within a period of less than one frame period, wherein the series of operations include the face detecting operation of the face detecting unit 23 for detecting a face area in the image data of the luminance color difference signals stored in the buffer memory, operation of the compression/expansion unit 20 for compressing the image data of the luminance color difference signals stored in the buffer memory and storing the compressed image data in the buffer memory, and operation of reading the compressed image data from the buffer memory and storing the read image data in the flash memory 22.

Hereinafter, the frame image data which is obtained in the exposure mode “A” is referred to as “frame image data “A” and the frame image data which is obtained in the exposure mode “B” is referred to as “frame image data “B”. The frame image data is displayed with the number attached to, wherein the number indicates how many pieces of frame image data were shot before the displayed frame image data. The number is counted up from the number of “0”.

For instance, the frame image data A0 in FIG. 2 is frame image data shot for the 0-th time in the exposure mode “A”. The frame image data B1 is frame image data shot for the first time in the exposure mode “B”.

In the present embodiment, the shooting operation is performed in the exposure mode “A” at first, and then the exposure mode “A” is switched to the exposure mode “B”, and the shooting operation is performed in the exposure mode “B”. The frame image data shot in the exposure mode “A” is expressed in frame image data A(2n), and the frame image data shot in the exposure mode “B” is expressed in frame image data B(2n+1), where “n”=0, 1, 2, 3, . . . . . The term “n” is referred to as a frame number.

As shown in FIG. 2, the frame image data A shot in the exposure mode A is used for the face detecting purpose, and the frame image data B shot in the exposure mode B is used for the displaying and recording purpose.

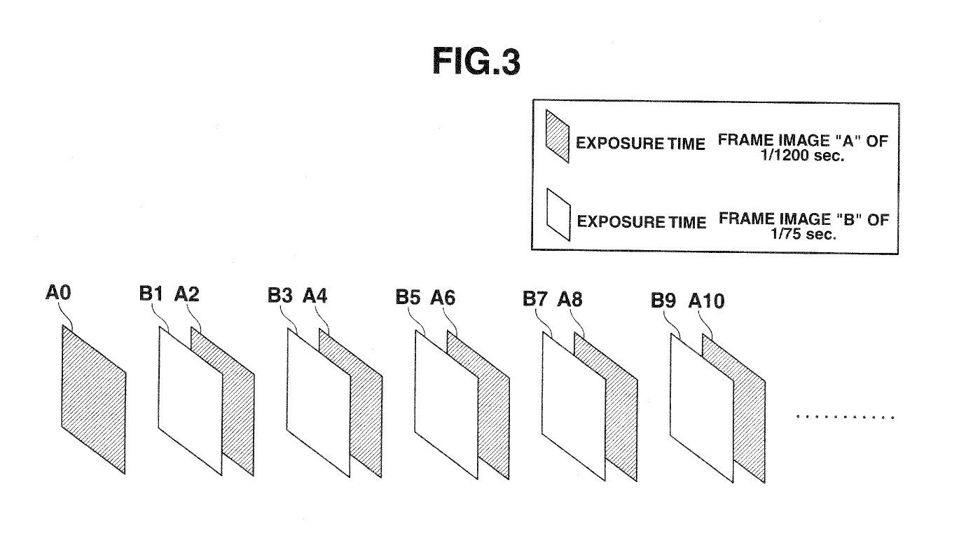

FIG. 3 is a view illustrating plural pieces of obtained frame image data.

As shown in FIG. 3, the frame image data “A” and frame image data “B” are shot or obtained alternately in the exposure mode “A” and the exposure mode “B”, and the number attached to the frame image data indicates the shooting order at which such frame image data is shot.

The shooting operation is performed alternately in the exposure mode “A” and the exposure mode “B”, wherein the exposure time in the exposure mode “A” is less than one frame period and the exposure time in the exposure mode “B” is equivalent to four frame periods. Therefore, both the shooting period of frame image data (frame image data “A”) in the exposure mode “A” and the shooting period of frame image data (frame image data “B”) in the exposure mode “B” will be 1/60 sec.

In a real-time displaying operation, only plural pieces of frame image data (frame image data B) shot in the exposure mode “B” are sequentially displayed, as shown in FIG. 2.

AF controlling process is performed only based on the frame image data (frame image data A) shot in the exposure mode “A”. In other words, AF controlling process is performed based on AF evaluation value of AF area in the shot frame image data “A”.

Hereinafter, for the explanation purpose, the moving image shooting operation is separated into a moving image shooting/recording operation, a real-time displaying operation in the moving image shooting/recording process, and AF controlling operation in the moving image shooting/recording process, and the moving image shooting operation, real time displaying operation and AF controlling operation will be described separately.

### B-1. Moving Image Shooting/Recording Operation

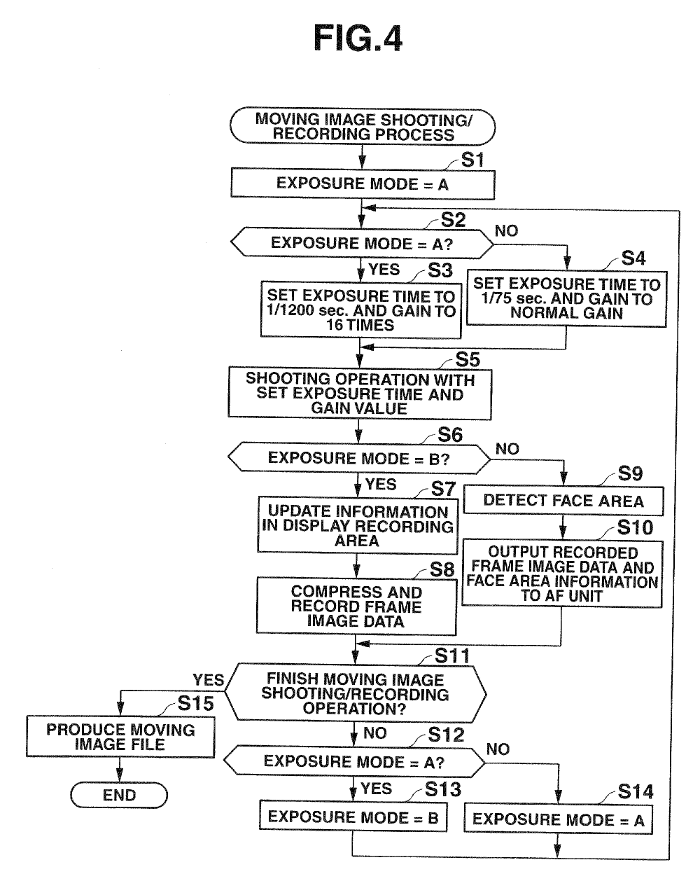

The moving image shooting/recording operation will be described with reference to a flow chart shown in FIG. 4.

In the moving image shooting mode, when the shutter button of the key input unit 11 is pressed by the user, that is, when a manipulation signal is sent to CPU 10 from the key input unit 11 in response to the user's pressing operation of the shutter button, CPU 10 determines that the moving image shooting/recording process has started and sets the exposure mode “A” at step S1. Data in an exposure-mode recording area of the buffer memory is renewed when the exposure mode “A” is set at step S1. In short, a term “A” is newly stored in the exposure mode recording area of the buffer memory.

CPU 10 judges at step S2 whether or not the exposure mode “A” has been set currently. The judgment is made based on data stored in the exposure mode recording area of the buffer memory.

When it is determined at step S2 that the exposure mode “A” has been set (YES at step S2), CPU 10 sets the exposure time to 1/1200 sec. and the gain value to 16 times of the normal gain value at step S3, and then advances to step S5. The normal gain value is a gain value set when the shooting operation is performed in the exposure mode “B”. Now, since the exposure time has been set to 1/1200 sec. in the exposure mode “A” and the exposure time has been set to 1/75 sec. in the exposure mode “B”, the exposure time in the exposure mode “A” will be 1/16 of the exposure time in the exposure mode “B”. Therefore, when the gain value for the exposure mode “A” is set to 16 times of the normal gain value, the frame image data “A” shot in the exposure mode “A” and the frame image data “B” shot in the exposure mode “B” are balanced in luminance level.

Meanwhile, when it is determined at step S2 that the exposure mode “A” has not been set (NO at step S2), that is, when it is determined at step S2 that the exposure mode “B” has been set, CPU 10 sets the exposure time to 1/75 sec. and the gain value to the normal gain value at step S4 and then advances to step S5.

CPU 10 performs the shooting operation using the exposure time and the gain value set at step S4. In other words, image data accumulated on CCD 5 during the exposure time set at step S4 is read, and a gain of the read image data is adjusted based on the set gain value of AGC of the unit circuit 8, and then image data of the luminance color difference signals is produced from the image data adjusted by the image producing unit 15. The produced image data is stored in the buffer memory (step S5).

CPU 10 judges at step S6 whether or not the exposure mode “B” has been set currently.

When it is determined at step S6 that the exposure mode “B” has been set (YES at step S6), CPU 10 stores, at step S7, in a display recording area of the buffer memory information (address information of the frame image data) specifying frame image data shot most recently to be displayed next. That is, the information is updated in the display recording area of the buffer memory. In this way, only the frame image data “B” shot in the exposure mode “B” is specified to be displayed, and only the frame image data “B” is sequentially displayed. At this time, CPU 10 keeps the specified frame image data in the buffer memory until such specified frame image data is displayed on the display unit 18.

When the information stored in the display recording area of the buffer is updated, CPU 10 makes the compression/expansion unit 20 compress the image data of the frame image data “B” and starts recording the compressed frame image data “B” in the flash memory 22 at step S8, and advances to step S11.

Meanwhile, when it is determined at step S6 that the exposure mode “B” has not been set currently (NO at step S6), that is, when it is determined that the exposure mode “A” is set currently, CPU 10 sends the face detecting unit 23 the frame image data shot and recorded most recently, and makes the face detecting unit 23 perform the face detecting process to detect a face area in the frame image data at step S9. As the result, only the frame image data “A” shot in the exposure mode “A” is used in the face detecting process. Information of the face area detected by the face detecting unit 23 is sent to CPU 10. Information of the face area includes data of a position and size of the face area detected by the face detecting unit 23.

Further, CPU 10 sends AF controlling unit 24 the frame image data shot and recorded most recently and information (face area information) of the face area detected by the face detecting unit 23 at step S10 and advances to step S11.

Then, CPU 10 judges at step S11 whether or not the moving image shooting/recording process is to be finished. The judgment is made depending on whether or not a manipulation signal has been sent to CPU 10 from the key input unit 11 in response to the user's pressing manipulation on the key input unit 11.

When it is determined at step S11 that the moving image shooting/recording process is not to be finished (NO at step S11), CPU 10 judges at step S12 whether or not the exposure mode “A” has been set.

When it is determined at step S12 that the exposure mode “A” has been set currently (YES at step S12), CPU 10 sets the exposure mode “B” at step S13, and returns to step S2. At the same time, CPU 10 updates the information in the exposure mode recording area of the buffer memory.

Meanwhile, when it is determined at step S12 that the exposure mode “A” is not set currently, that is, that the exposure mode “B” has been set currently (NO at step S12), CPU 10 sets the exposure mode “B” at step S14, and returns to step S2. At the same time, CPU 10 updates the information in the exposure mode recording area of the buffer memory.

When CPU 10 operates as described above, the frame image data “A” and the frame image data “B” are shot in turn repeatedly, and only plural pieces of frame image data “B” are sequentially recorded, as shown in FIG. 3. As the result, moving image data for reproducing a smooth moving image can be recorded. Further, since the face detecting process is performed depending on the frame image data “A” which is shot using a short exposure time, the face area can be detected with accuracy.

Meanwhile, when it is determined at step S11 that the moving image shooting/recording process is to be finished (YES at step S11), CPU 10 produces a moving image file using the recorded frame image data at step S15.

### B-2. Real-Time Displaying Operation in Moving Image Shooting/Recording Process

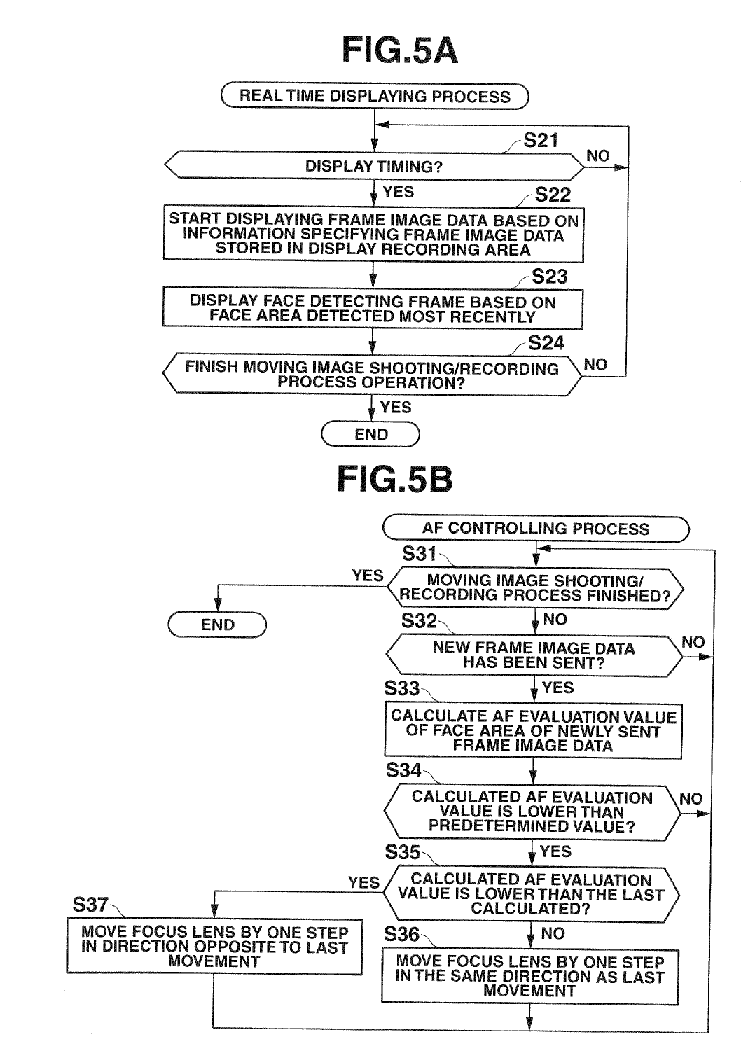

The real-time displaying operation in the moving image shooting/recording process will be described with reference to a flow chart of FIG. 5(A).

When the moving image shooting/recording process starts, CPU 10 judges at step S21 whether or not it has reached a display timing. The display timing comes every 1/60 sec. Since the frame image data “A” is shot every 1/60 sec. and also the frame image data “B” is shot every 1/60 sec., the display timing is set so as to come every 1/60 sec. That is, for displaying in real time moving image data “B” consisting of plural pieces of frame image data “B”, the display timing is set so as to come every 1/60 sec.

When it is determined at step S21 that the display timing has not yet come, CPU 10 repeatedly judges at step S21 whether or not the display timing has come until it is determined that the display timing has come. When the display timing has come (YES at step S21), CPU 10 starts displaying the frame image data “B” stored in the buffer memory based on the frame image data specified to be displayed next in those currently stored in the display recording area (step S22). Since information for specifying frame image data to be displayed next is stored in the display recording area at step S7 in FIG. 4, the frame image data “B” can be displayed at step S22.

Then, CPU 10 starts displaying in an overlapping fashion a face detecting frame on the frame image data “B” displayed at step S22, based on the face area detected most recently (step S23). In other words, the face detecting frame is displayed on the frame image data “B” in an overlapping manner based on the face area information of the frame image data “A” detected most recently. In short, the face detecting frame is displayed on the frame image data “B” in an overlapping manner based on the face area information of the frame image data “A” which has been shot just before the frame image data currently displayed.

CPU 10 judges at step S24 whether or not the moving image shooting/recording process is to be finished. The judgment is made in a similar manner to step S11 in FIG. 4, that is, the judgment is made depending on whether or not a manipulation signal has been sent to CPU 10 from the key input unit.

When it is determined at step S24 that the moving image shooting/recording process should not be finished (NO at step S24), CPU 10 returns to step S21.

AS described above, in the moving image shooting/recording process, the shooting operation is performed in the exposure mode “A” (exposure time is 1/1200 sec.) and the exposure mode “B” (exposure time is 1/75 sec.) in turn repeatedly, and plural pieces of frame image data “B” shot in the exposure mode “B” are successively displayed, and also the face detecting frame is displayed at the same area as the face area detected in the frame image data “A”, whereby moving image data for smooth moving image can be displayed in real time and the detected face area can definitely be displayed.

### B-3. AF Operation in the Moving Image Shooting/Recording Process

AF controlling operation in the moving image shooting/recording process will be described with reference to a flow chart of FIG. 5(B).

When the moving image shooting/recording process starts, AF controlling unit 24 judges at step S31 whether or not the moving image shooting/recording process has been finished.

When it is determined at step S31 that the moving image shooting/recording process has not yet been finished, AF controlling unit 24 judges at step S32 whether or not new frame image data shot in the exposure mode “A” has been sent. When the frame image data “A” and face area information have been output at step S10 in FIG. 4, it is determined that new frame image data has been sent to AF controlling unit 24.

When it is determined at step S32 that new frame image data has not been sent to AF controlling unit 24 (NO at step S32), the operation returns to Step 31. When it is determined at step S32 that new frame image data has been sent to AF controlling unit 24 (YES at step S32), AF controlling unit 24 calculates AF evaluation value of the image data within the face area based on the face area information of the new frame image data (step S33). The detected face area is used as AF area.

AF controlling unit 24 judges at step S34 whether or not the calculated AF evaluation value of the image data is lower than a predetermined value. In the case where plural face areas (plural AF areas) have been detected, AF controlling unit 24 can judge whether or not all the calculated AF evaluation values of the face area of the image data are lower than the predetermined value, or AF controlling unit 24 can judge whether or not a mean value of the calculated AF evaluation values of the face areas of the image data is lower than the predetermined value, or AF controlling unit 24 can judge whether or not the calculated AF evaluation values of the largest face area of the image data is lower than the predetermined value.

When it is determined at step S34 that the calculated AF evaluation value is not lower than the predetermined value (NO at step S34), the operation returns to step S31. When it is determined at step S34 that the calculated AF evaluation value is lower than the predetermined value (YES at step S34), AF controlling unit 24 determines that the camera does not come into focus, and further judges whether or not the calculated AF evaluation value is lower than the AF evaluation value calculated last (step S35).

When it is determined at step S35 that the calculated AF evaluation value is not lower than the AF evaluation value calculated last (NO at step S35) AF controlling unit 24 sends a control signal to the lens driving unit 3 at step S36 to move the focus lens by one step in the same direction as the direct ion in which the focus lens is moved previously, and returns to step S31.

When it is determined at step S35 that the calculated AF evaluation value is lower than the AF evaluation value calculated last (YES at step S35), AF controlling unit 24 sends a control signal to the lens driving unit 3 at step S37 to move the focus lens by one step in the direction opposite to the direction in which the focus lens is moved previously, and returns to step S31.

As described above, since AF evaluation value of the face area detected in the frame image data shot in the exposure mode “A” is calculated, AF evaluation value can be calculated with accuracy, and AF controlling process can be enhanced.

In the first embodiment described above, the shooting operation is performed using a short exposure time and a long exposure time in turn repeatedly, and the frame image data shot using the long exposure time is stored and displayed as moving image data and the frame image data shot with the short exposure time is used in the face detecting process and AF controlling process, whereby moving image data for reproducing smooth moving image can be stored and displayed. Further, the face detecting process and calculation accuracy of AF evaluation value can be enhanced. Furthermore, accuracy in AF controlling process can be enhanced.

It is possible to send a control signal to the lens driving unit 3 based on a size of the detected face area to move the zoom lens. In other words, based on the size of the face area detected in the frame image data “A” shot in the exposure mode “A”, the position of the zoom lens is adjusted in the shooting operation in the exposure mode “B”, whereby moving data for keeping the size of the face area constant can be recorded and displayed.

### Second Embodiment

Now, the second embodiment of the invention will be described.

In the first embodiment, the face detecting process is performed and AF evaluation value is calculated, using the frame image data “A” shot in the exposure mode “A”, but in the second embodiment, the face detecting process is performed using the frame image data “A” shot in the exposure mode “A” and the frame image data “B” shot in the exposure mode “B”, and the frame image data in which more face areas can be detected is used to calculate AF evaluation value.

### C. Moving Image Shooting Operation

In the second embodiment, the image pick-up apparatus according to the present invention will be realized in a digital camera with a similar configuration to that show in FIG. 1.

A moving image shooting operation of the digital camera 1 in the second embodiment will be described, but only different operation form the first embodiment will be described. In the second embodiment, both the frame image data “A” shot in the exposure mode “A” and the frame image data “B” shot in the exposure mode “B” are used in the face detecting process.

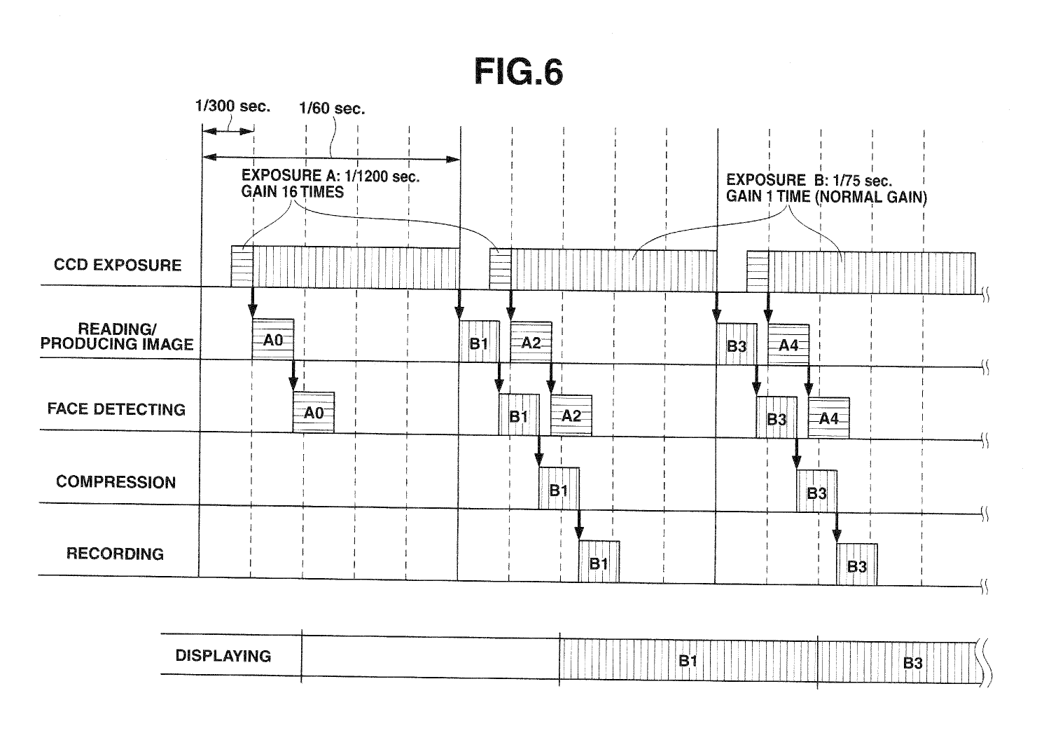

FIG. 6 is a time chart of the moving image shooting operation in the second embodiment. As shown in FIG. 6, the face detecting process is performed on the frame image data “B”, too.

Frame image data in which more face areas have been detected is selected from among the frame image data “A” and frame image data “B”, and is sent to AF controlling unit 24. Then, AF controlling unit 24 calculates AF evaluation value using the received frame image data. Frame image data in which more face areas have been detected is selected from among the frame image data “A” and frame image data “B” shot just after the frame image data “A” and the selected frame image data is used in AF controlling process. Therefore, either the frame image data “A” or frame image data “B” is used in AF controlling process on a case-by-case basis.

Further, the face detecting frame is displayed based on the face area information of the frame image data in which more face areas have been detected, selected from the frame image data “A” and frame image data “B”.

Hereinafter, for explanation purpose, the moving image shooting operation is separated into a moving image shooting/recording operation, a face detecting operation in the moving image shooting/recording process, and the moving image shooting/recording operation and the face detecting operation will be described separately. The real time displaying operation and AF controlling operation in the moving image shooting/recording operation are substantially the same as those in the first embodiment shown in FIGS. 5(A) and 5(B), and will be described briefly in the last.

### C-1. Moving Image Shooting/Recording Operation

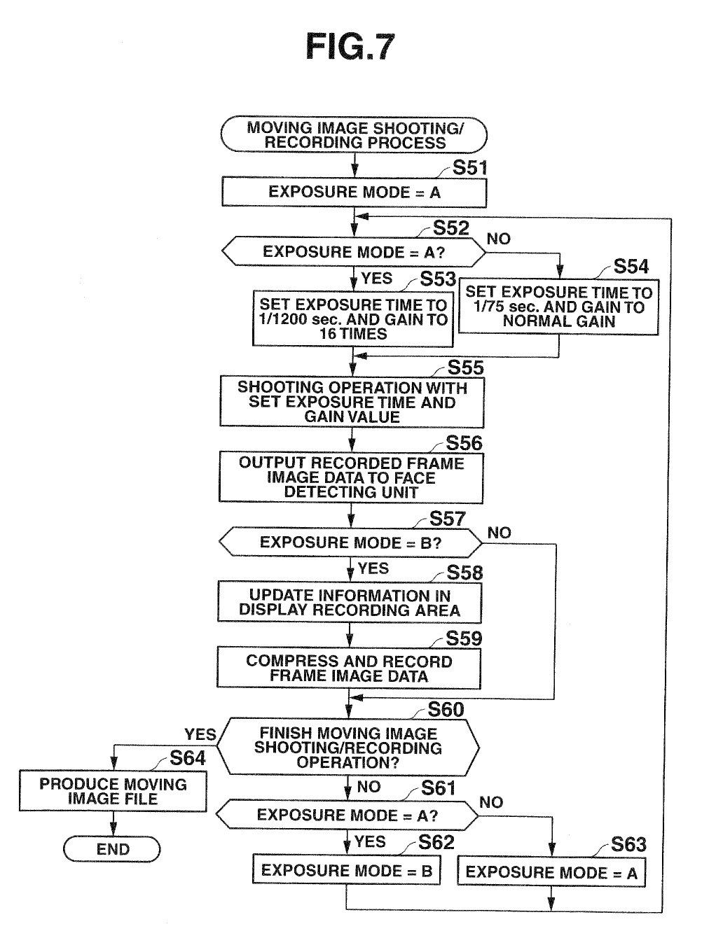

The moving image shooting/recording operation will be described with reference to a flow chart shown in FIG. 7.

In the moving image shooting mode, when the shutter button of the key input unit 11 is pressed by the user, that is, when a manipulation signal is sent to CPU 10 from the key input unit 11 in response to the user's pressing operation of the shutter button, CPU 10 determines that the moving image shooting/recording process has started and sets the exposure mode “A” at step S51. Information stored in the exposure mode recording area of the buffer memory is renewed when the exposure mode “A” is set at step S51. In short, a term “A” is stored in the exposure mode recording area of the buffer memory.

CPU 10 judges at step S52 whether or not the exposure mode “A” has been set currently. The judgment is made based on the information stored in the exposure mode recording area of the buffer memory.

When it is determined at step S52 that the exposure mode “A” has been set (YES at step S52), CPU 10 sets the exposure time to 1/1200 sec. and the gain value to 16 times of a normal gain value at step S53, and then advances to step S55.

Meanwhile, when it is determined at step S52 that the exposure mode “A” has not been set (NO at step S52), that is, when it is determined that the exposure mode “B” is set currently, CPU 10 sets the exposure time to 1/75 sec. and the gain value to the normal gain value at step S54 and then advances to step S55.

At step S55, CPU 10 performs the shooting operation using the exposure time and the gain value set at step S54. In other words, image data accumulated on CCD 5 during the exposure time set at step S54 is read, and a gain of the read image data is adjusted based on the set gain value of AGC of the unit circuit 8, and then image data of the luminance color difference signals is produced from gain adjusted image data by the image producing unit 15. The produced image data is stored in the buffer memory (step S55).

Then, CPU 10 outputs the frame image data shot recorded most recently to the face detecting unit 23 at step S56.

CPU 10 judges at step S57 whether or not the exposure mode “B” has been set.

When it is determined at step S57 that the exposure mode “B” is set currently (YES at step S57), CPU 10 stores in the display recording area of the buffer memory information (address information of the frame image data) specifying frame image data shot and recorded most recently to be displayed next (step S58). That is, the information is updated in the display recording area of the buffer memory. In this way, only the frame image data “B” shot in the exposure mode “B” is specified to be displayed, and only plural pieces of frame image data “B” are sequentially displayed. At this time, CPU 10 keeps the specified frame image data in the buffer memory until such specified frame image data is displayed on the display unit 18.

When the information stored in the display recording area of the buffer is updated, CPU 10 makes the compression/expansion unit 20 compress the image data of the frame image data “B” and starts recording the compressed frame image data “B” in the flash memory 22 at step S59, and advances to step S60.

Meanwhile, when it is determined at step S57 that the exposure mode “B” is not set currently (NO at step S57), the operation advances to step S60.

Then, CPU 10 judges at step S60 whether or not the moving image shooting/recording process is to be finished. The judgment is made depending on whether or not a manipulation signal has been sent to CPU 10 from the key input unit 11 in response to the user's pressing manipulation on the key input unit 11.

When it is determined at step S60 that the moving image shooting/recording process is not to be finished (NO at step S60), CPU 10 judges at step S61 whether or not the exposure mode “A” has been set.

When it is determined at step S61 that the exposure mode “A” is set currently (YES at step S61), CPU 10 sets the exposure mode “B” at step S62, and returns to step S52. At the same time, CPU 10 updates the information in the exposure mode recording area of the buffer memory.

Meanwhile, when it is determined at step S61 that the exposure mode “A” has not been set, that is, when it is determined that the exposure mode “B” is set currently, CPU 10 sets the exposure mode “A” at step S63, and returns to step S52. At the same time, CPU 10 updates the information in the exposure mode recording area of the buffer memory.

When CPU 10 operates as described above, the frame image data “A” and the frame image data “B” are shot in turn repeatedly, wherein the frame image data “A” is shot using the exposure time of 1/1200 sec. and the frame image data “A” is shot using exposure time of 1/75 sec., and only plural pieces of frame image data “B” shot using the exposure time of 1/75 sec. are sequentially recorded, as shown in FIG.6. As the result, moving image data for reproducing a smooth moving image can be recorded.

Meanwhile, when it is determined at step S60 that the moving image shooting/recording process is to be finished (YES at step S60), CPU 10 produces a moving image file using the recorded frame image data at step S64.

### C-2. Face Detecting Operation in Moving Image Shooting/Recording Process

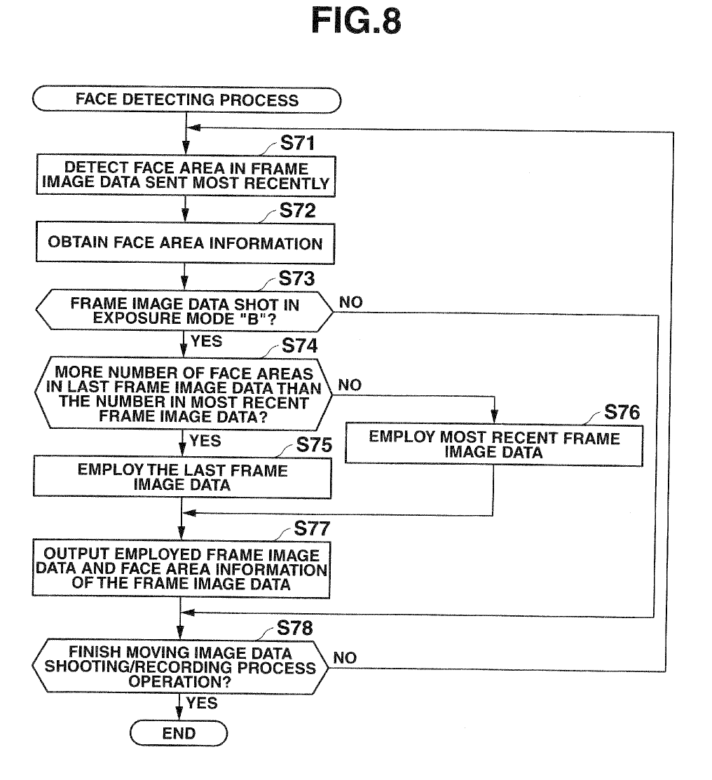

Now, the face detecting operation in the moving image shooting/recording process in the second embodiment will be described with reference to a flow chart of FIG. 8.

When the moving image shooting/recording operation starts, the face detecting unit 23 performs the face detecting process to detect a face area in the frame image data sent most recently at step S71.

Then, CPU 10 obtains information (face area information) of the detected face area at step S72. The face area information includes data of a position and size of the detected face area.

Further, CPU 10 judges at step S73 whether or not the frame image data sent most recently is the frame image data “B” shot In the exposure mode “B”.

When it is determined at step S73 that frame image data sent most recently is the frame image data “B” shot in the exposure mode “B” (YES at step S73), CPU 10 judges at step S74 whether or not more face areas have been detected in the frame image data (frame image data “A”) shot just before the above frame image data “B” than in the above frame image data “B”. That is, it is judged in which frame image data “A” or “B” more face areas have been detected.

When it is determined at step S74 that more face areas have been detected in the frame image data “A” shot just before the above frame image data “B”, CPU 10 employs the frame image data “A” shot just before the above frame image data “B” at step S75, and advances to step S77. In the case where even number of face areas have been detected in the frame image data “A” shot just before and in the frame image data “B” in which the face areas have been detected most recently, CPU 10 employs the frame image data “A” shot just before the above frame image data “B”.

Meanwhile, it is determined at step 574 that more face areas have been detected in the above frame image data “B”, CPU 10 employs the frame image data “B” at step S76, and advances to step S77.

At step S77, CPU 10 outputs the employed frame image data and the face area information of said frame image data to AF controlling unit 23, and advances to step S78.

Meanwhile, when it is determined at step S73 that frame image data sent most recently is not the frame image data “B” shot in the exposure mode “B” (NO at step S73), CPU 10 advances directly to step S78, where CPU 10 judges whether or not the moving image shooting/recording process is to be finished.

When it is determined at step S78 that the moving image shooting/recording process is not finished, CPU 10 returns to step S71.

### C-3. Real Time Displaying Operation and AF Controlling Operation in the Second Embodiment

A real time displaying operation and AF controlling operation in the second embodiment will be described briefly.

The real time displaying operation in the second embodiment is substantially the same as the operation shown in the flow chart of FIG. 5(A). In the second embodiment, the face detecting frame is not displayed based on the face area detected most recently at step S23, but the face detecting frame is displayed in accordance with the face area information of the frame image data employed most recently at step S75 or S76 in FIG. 8. In other words, in the second embodiment, the face detecting frame is displayed in accordance with the face area information of the frame image data in which more face areas have been detected, selected from the frame image data “B” shot most recently and the frame image data “A” shot just before said frame image data “B”.

The AF controlling operation in the second embodiment is substantially the same as the operation shown in the flow chart of FIG. 5(B). In the second embodiment, since the employed frame image data is sent from AF controlling unit 24, the frame image data “A” or frame image data “B” can be sent to AF controlling unit 24. In other words, in the second embodiment, the frame image data in which many face areas have been detected is sent to the AF controlling unit 24, and AF controlling process is performed using the sent frame image data.

As described above, the shooting operation is performed using a short exposure time and a long exposure time in turn repeatedly in the second embodiment. The frame image data shot using the long exposure time is recorded as a moving image data, and the frame image data is employed, in which more face areas have been detected, selected from the frame image data “A” and frame image data “B”. Therefore, a stable face detecting process can be performed and AF evaluation value can be calculated regardless of the state of the object to be shot.

### Modifications to Embodiments of the Invention

Modifications may be made to the embodiments described above as follows:

(01) In the above embodiments, the shooting operation using a short exposure time and the shooting operation using a long exposure time are performed in turn repeatedly. But in place of the above shooting operations, the shooting method may be adopted, in which the shooting operations which are continuously performed using a short exposure time once or plural times and the shooting operations which are continuously performed using a long exposure time once or plural times are performed in turn repeatedly.

In other words, the shooting method is repeatedly performed, in which the shooting operation using an exposure time is performed once or plural times and then the shooting operation using other exposure time is performed once or plural times, whereby moving image data for reproducing a smooth moving image can be recorded and displayed, and the face detecting process and accuracy in calculation of AF evaluation value are enhanced.

(02) In the embodiments, the frame image data “B” shot in the exposure mode “B” is displayed in real time. Modification may be made to the above embodiments, such that the user is allowed to select the frame image data to be displayed, thereby displaying the frame image data “A” or the frame image data “B”.

Another modification may be made to the second embodiment, such that the frame image data employed at step S75 or 76 is displayed in real time. In other words, the frame image data in which more face areas have been detected is displayed in real time.

(03) In the above embodiments, the shooting operations are performed using two different exposure times, but plural exposure times (more than two exposure times) may be used for the shooting operation. In this case, moving image data for reproducing a smooth moving image can be recorded and displayed, and the face detecting process and accuracy of calculation of AF evaluation value are enhanced.

(04) In the above embodiments, taking the face area detecting process and AF evaluation value as an example, the image evaluation is described. The image evaluation may be made in the case of evaluating a moving vector of the image data.

(05) In the above embodiments, the fame image data “A” shot in the exposure time “A” shorter than the exposure time “B” is subjected to the face detecting process and AF controlling process. But the fame image data “A” shot in the exposure time “A” may be subjected to either one of the face detecting process and AF controlling process. In the case where the fame image data “A” is subjected only to AF controlling process, AF evaluation value of a predetermined AF area or an arbitrary AF area is calculated. The AF evaluation value thus calculated is used in AF controlling operation. In this case, accuracy of the image evaluation is enhanced and also accuracy of AF controlling operation is enhanced.

(06) In the above embodiments, the focusing position of the focus lens is set to the lens position where AF evaluation is larger than the predetermined value. Modification may be made such that the lens position where the AF evaluation value takes the peak value is detected, and then the focus lens is instantly moved to the detected lens position.

(07) In the above embodiments, the moving image shooting/recording process is described with reference to the flow charts of FIGS. 4 and 7. The moving image shooting/recording process may be performed while a through image is being displayed in a moving image shooting mode or in a still image shooting mode. In this case, the recording operation of recording the compressed frame image data at step S8 in FIG. 4 and step S59 in FIG. 7 can be skipped. Further, it is judged at step S11 in FIG. 4 and S60 in FIG. 7 whether or not the moving image shooting/recording operation or a still image shooting/recording operation is finished, and when the moving image shooting/recording operation or the still image shooting/recording operation is continued, the moving image shooting/recording process or the still image shooting/recording process is performed. In short, both the recording operation and displaying operation of the frame image data are not performed, but only the displaying operation is performed.

(08) In the above embodiments, the frame image data is recorded and displayed, but only the operation of recording the frame image data maybe performed. In this case, the operations at steps S7 in FIG. 4 and S58 in FIG. 7, and the operation of the flow chart of FIG. 5(A) can be omitted.

(09) In the above embodiments, the frame image data “A” shot in the exposure mode “A” is recorded and displayed, and the frame image data “B” shot in the exposure mode “B” is used to evaluate frame image data. Modification may be made such that the frame image data “A” shot in the exposure mode “A” is recorded as moving image data and the frame image data “B” shot in the exposure mode “B” is associated with the moving image data and recorded for evaluating an image. In short, without valuating the image during the moving image data shooting process, the frame image data “A” and “B” are associated with each other and recorded. In this case, the frame image data “A” may be displayed in real time and the frame image data “B” may be displayed in real time.

The modification allows to display a smooth moving image and to enhance accuracy of an image evaluation in the face detecting process while the moving image data is being displayed.

Further, other modification may be made such that when plural pieces of frame image data are displayed, the moving image data including the frame image data “A” shot in the exposure mode “A” is displayed and the frame image data “B” shot in the exposure mode “B” is used for the image evaluation. In other words, the frame image data “A” is displayed and the face detecting process and a moving vector calculating process are performed based on the frame image data “B”. It is possible to display a certain information on the displayed frame image data “A” in an overlapping fashion, based on the results obtained in the face detecting process and moving vector calculating process.

This other modification allows to display a smooth moving image and to enhance accuracy of an image evaluation in the face detecting process while the moving image data is being displayed.

(10) In the second embodiment, the face area information is obtained from the frame image data “B” shot most recently or the frame image data “A” shot just before said frame image data “B”. But the face area information may be obtained from the frame image data “B” or the frame image data “A” shot just after said frame image data “B”. The point is that two pieces of frame image data have been specified.

(11) In the above embodiments, exposure times of different lengths, such as a long exposure time and a short exposure time, are used. In place of using exposure times of different lengths, exposure condition may be changed for shooting operation, whereby image data for displaying a smooth moving image may be recorded and displayed, and accuracy of the face detecting operation and calculation of AF evaluation value (accuracy of image evaluation) are enhanced.

(12) The above modifications (01) and (11) may be arbitrarily combined to the extent that no conflict yields.

(13) The embodiments of the invention and the modifications are described to illustrate preferred embodiments of the inventions only for better understanding of the principle and structure of the invention, but by no means restrict the scope of the inventions defined in the accompanying claims.

Therefore, it should be understood that various sorts of alternations and modifications to be made to the above embodiments of the invention will fall within the scope of the invention and are protected under the accompanying claims.

Any apparatus that records frame image data shot using a long exposure time and uses frame image data shot using a short exposure time for evaluating an image is protected under the accompanying claims.

In the above embodiments, the image pick-up apparatus of the invention which is used in the digital camera 1 is described, but the invention is not restricted to the invention used in the digital camera, and the invention may be used in any apparatus which is capable of reproducing an image.

What is claimed is:

1. An image pick-up apparatus comprising:
an image pick-up unit for shooting an object;
a first shooting control unit for controlling the image pick-up unit to shoot the object at least once under a first exposure condition, thereby obtaining first image data;
an image evaluating unit for evaluating an image of the first image data obtained by the first shooting control unit;
a shooting condition adjusting unit for adjusting a shooting condition to be set to the image pick-up unit based on an evaluation result by the image evaluating unit;
a second shooting control unit for controlling the image pick-up unit to shoot the object at least once with the shooting condition adjusted by the shooting condition adjusting unit under a second exposure condition different from the first exposure condition, thereby obtaining second image data;
an image data obtaining unit for performing shooting by the first shooting control unit and shooting by the second shooting control unit in turn repeatedly, thereby obtaining plural pieces of image data; and
a moving image data producing unit for producing moving image data from plural pieces of second image data, wherein the plural pieces of second image data are included in the plural pieces of image data obtained by the image data obtaining unit.

2. The image pick-up apparatus according to claim 1, wherein the first shooting control unit controls the image pick-up unit to shoot once under the first exposure condition, and the second shooting control unit controls the image pick-up unit to shoot once under the second exposure condition.

3. The image pick-up apparatus according to claim 1, wherein the image pick-up unit includes a focus lens, and the image evaluating unit comprises a calculating unit for calculating AF evaluation value from the first image data obtained by the first shooting control unit, and the shooting condition adjusted by the shooting condition adjusting unit includes a lens position of the focus lens to be moved based on the AF evaluating value calculated by the calculating unit.

4. The image pick-up apparatus according to claim 3, further comprising:
a face detecting unit for detecting a face area in the first image data obtained by the first shooting control unit, wherein the calculating unit calculates an AF evaluation value of the face area detected by the face detecting unit.

5. The image pick-up apparatus according to claim 4, wherein the face detecting unit detects a face area in the second image data obtained by the second shooting control unit, and the image evaluating unit compares the number of the face areas detected in the first image data with the number of the face areas detected in the second image data, and selects and employs image data in which more face areas have been detected by the face detecting unit out of the first and second image data, wherein the employed image data is used by the image evaluating unit to evaluate an image.

6. The image pick-up apparatus according to claim 1, further comprising:
a recording medium for recording image data; and
a recording control unit for associating the moving image data produced by the moving image data producing unit with the image data which has been evaluated by the image evaluating unit, and recording the associated data in the recording medium.

7. The image pick-up apparatus according to claim 4, further comprising:
a first display unit for displaying the moving image data produced by the moving image data producing unit and the face area detected by the face detecting unit.

8. The image pick-up apparatus according to claim 5, further comprising:
a second display unit for displaying the moving image data produced by the moving image data producing unit and the face area of the image data employed by -the image evaluating unit.

9. The image pick-up apparatus according to claim 1, wherein the first exposure condition is an exposure time of a predetermined length and the second exposure condition is an exposure time longer the exposure time of the first exposure condition.

10. A computer readable recording medium to be mounted on an image pick-up apparatus having a built-in computer, the computer readable recording medium storing a computer program when executed to make the computer function as an image pick-up unit comprising:
an image pick-up unit for shooting an object;
a first shooting control unit for controlling the image pick-up unit to shoot the object at least once under a first exposure condition, thereby obtaining first image data;
an image evaluating unit for evaluating an image of the first image data obtained by the first shooting control unit;
a shooting condition adjusting unit for adjusting a shooting condition to be set to the image pick-up unit based on an evaluation result by the image evaluating unit;
a second shooting control unit for controlling the image pick-up unit to shoot the object at least once with the shooting condition adjusted by the shooting condition adjusting unit under a second exposure condition different from the first exposure condition, thereby obtaining second image data;
an image data obtaining unit for performing shooting by the first shooting control unit and shooting by the second shooting control unit in turn repeatedly, thereby obtaining plural pieces of image data; and
a moving image data producing unit for producing moving image data from plural pieces of second image data obtained by the second shooting control unit, wherein the plural pieces of second image data are included in the plural pieces of image data obtained by the image data obtaining unit.
